(19) United States
(12) Patent Application Publication
(10) Pub. No.: US 2019/0100058 A1
(43) Pub. Date: Apr. 4, 2019

(54) TIRE MOLD AND TIRE

(71) Applicant: BRIDGESTONE CORPORATION, Tokyo (JP)

(72) Inventor: Yoshio KAJI, Tokyo (JP)

(73) Assignee: BRIDGESTONE CORPORATION, Tokyo (JP)

(21) Appl. No.: 16/088,987

(22) PCT Filed: Nov. 25, 2016
(86) PCT No.: PCT/JP2016/084919

§ 371 Date: Sep. 27, 2018

(30) Foreign Application Priority Data
Apr. 6, 2016 (JP) 2016-076377

(51) Int. Cl. B60C 11/12; B60C 11/03; B29D 30/06

(52) U.S. Cl. CPC B60C 11/1218; B29D 2030/0613; B29D 30/0606; B60C 11/0306

(57) ABSTRACT

A tire mold includes a mold surface for vulcanizing and molding a tire, and a blade for vulcanizing and molding a sipe formed in the mold surface. The blade includes a concave-convex surface in which a plurality of convex portions formed adjacent to each other and a plurality of concave portions formed between the adjacent convex portions adjacent to each other are formed. A length of the concave portion is smaller than a length of the convex portion in a concave-convex surface view. The concave portion is sharp in a depth direction of the concave portion.

### TECHNICAL FIELD

The present invention relates to a tire mold and a tire, in particular, a sipe opened to a wheel tread portion of a tire.

### BACKGROUND ART

A sipe is a cut opened to a wheel tread portion of a tire. The sipe is formed by a blade having a thin plate shape embedded in a vulcanizing mold for a tire. The sipe is served to remove a water screen formed between the wheel tread portion of the tire and a road surface when the tire travels on an ice and to enhance a resistance of the tire against the road surface. Conventionally, a tire in which a projection or a recess having various configurations is formed on a wall surface of the sipe so as to remove the water screen and to enhance draining performance is known.

For example, a fine concave and convex having a satin finished surface is formed on an inner wall surface of a sipe is disclosed in Patent Literature 1. Accordingly, surface tension of water entered into the sipe is relaxed so that the water in the sipe flows easily. Consequently, draining performance is improved.

### CITATION LIST

### Patent Literature

[PTL 1] Japanese Unexamined Patent Application Publication No. 2004-224213

### SUMMARY OF INVENTION

### Problems to be Solved by the Invention

However, Patent Literature 1 does not disclose a dimensional relationship, a positional relationship, shapes, and sizes of a concave portion and a convex portion in a concave-convex surface. The convex portions facing each other on the inner wall surfaces are not meshed depending on the shape of the concave-convex surface, and therefore sufficient friction is not generated. Consequently, rigidity of a block in which the sipe is formed might be deteriorated.

An object of the present invention is, in consideration of the problem described above, to provide a tire mold and a tire that optimize a relationship between a concave portion and a convex portion formed in the sipe, so that rigidity of a block in which a sipe is formed is improved.

### Means for Solving the Problems

A tire mold according to a first aspect includes a mold surface that vulcanizes and molds a tire, and a blade that vulcanizes and molds a sipe in a tire, the blade being formed in the mold surface. The blade includes a concave-convex surface in which a plurality of convex portions formed adjacent to each other and a plurality of concave portions formed between the convex portions adjacent to each other are formed. A length of the concave portion is smaller than a length of the convex portion in a concave-convex surface view. The concave portion is sharp in a depth direction of the concave portion.

In the first aspect, an average width length of the concave portions is set in a range between 0.0005 mm and 0.5 mm in the concave-convex surface view. Further, an area of the concave portion is set in a range between 0.0000002 mm² and 0.2 mm². Further, a depth of the concave portion is set in a range between 0.0001 mm and 0.25 mm.

In the first aspect, a first layer extended from one end to another end in a predetermined direction of the blade is formed on a side surface of the blade. The first layers are formed adjacent to each other in a direction orthogonal to the predetermined direction at an interval of 0.1 mm to 0.5 mm.

In the first aspect, a second layer extended from one end to another end in the predetermined direction of the blade is formed on the side surface of the blade. The second layers are formed between the first layers to be adjacent to each other in a direction orthogonal to the predetermined direction at an interval of 0.035 mm to 0.165 mm.

In the first aspect, a longer side length of the convex portion is set in a range between 0.085 mm and 0.4 mm, and a shorter side length of the convex portion is set in a range between 0.035 mm and 0.165 mm. Further, the convex portions are formed in a predetermined direction of the blade at an interval of 0.035 mm to 0.165 mm.

A tire according to a second aspect includes a tread surface, a plurality of circumferential direction grooves formed on the tread surface and extended in a tire circumferential direction, a plurality of lateral grooves formed on the tread surface and extended in a tire width direction, the lateral groove crossing the circumferential direction groove, a block formed in the tread surface and defined by a plurality of the circumferential direction grooves and a plurality of the lateral grooves, and a plurality of sipes extended in the tire width direction and formed in the block. Each of inner wall surfaces facing each other of the sipe includes a concave-convex surface in which a plurality of concave portions formed adjacent to each other and a plurality of convex portions formed between the concave portions adjacent to each other are formed. A length of the convex portion is smaller than a length of the concave portion in a concave-convex surface view. The convex portion is sharp in a depth direction of the convex portion.

In the second aspect, an average width length of the convex portions is set in a range between 0.0005 mm and 0.5 mm in the concave-convex surface view. Further an area of the convex portion is set in a range between 0.0000002 mm² and 0.2 mm². Further, a depth of the convex portion is set in a range between 0.0001 mm and 0.25 mm.

In the second aspect, a first layer extended from one side to another side in a predetermined direction of the sipe is formed on each of the inner wall surfaces facing each other of the sipe. The first layers are formed in a direction orthogonal to the predetermined direction to be adjacent to each other at an interval of 0.1 mm to 0.5 mm.

In the second aspect, a longer side length of the concave portion is set in a range between 0.085 mm and 0.4 mm, and a shorter side length of the concave portion is set in a range between 0.035 mm and 0.165 mm. Further, the concave portions are formed in a predetermined direction of the sipe at an interval of 0.035 mm and 0.165 mm.

### Effects of the Invention

According to the present invention, rigidity of the block in which the sipe is formed can be improved.

### BRIEF DESCRIPTION OF DRAWINGS

FIG. 1 is a plane view illustrating a tread surface of a tire according to an embodiment of the present invention.

FIG. 2 is a schematic partial cross-sectional view of a tire mold according to the embodiment of the present invention.

FIG. 3 is a perspective view of a blade according to the embodiment of the present invention.

FIG. 4(a) is an enlarged view of a region T of the blade according to the embodiment of the present invention. FIG. 4(b) is a cross-sectional view taken along line A-A shown in FIG. 4(a).

FIG. 5 is a graph illustrating a relationship between arithmetic average roughness Ra and a friction coefficient μ.

FIG. 6 is a graph illustrating a relationship between a arithmetic average roughness Ra and rigidity of a block.

### DESCRIPTION OF EMBODIMENTS

Hereinafter, an embodiment of the present invention is described with reference to the drawings. In the description of the drawings, the same reference numeral is assigned to the same part, and the description thereof is therefore omitted.

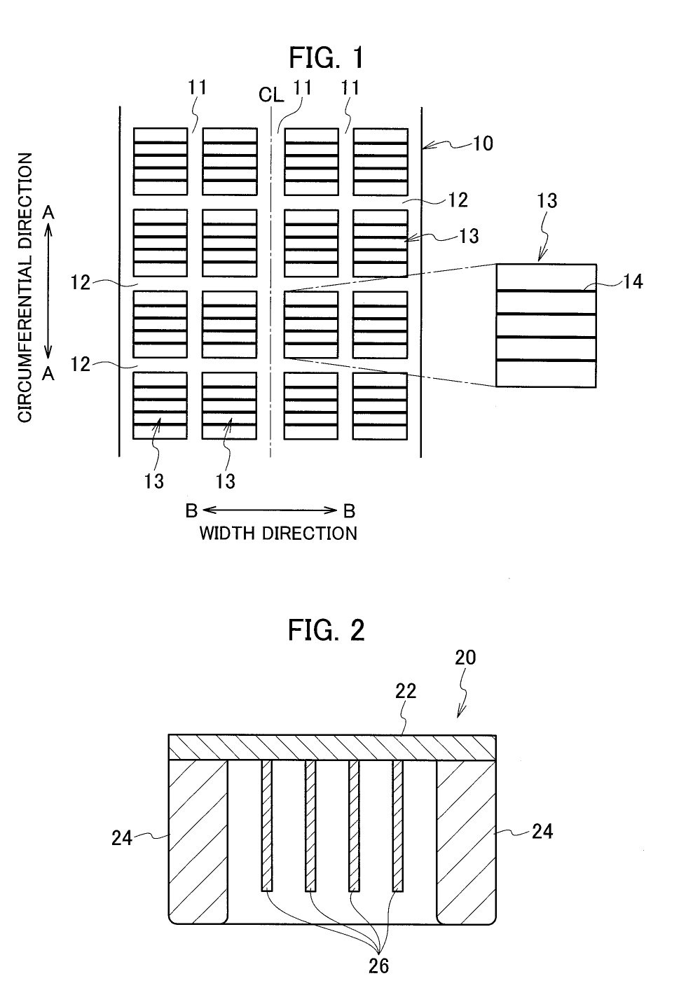

A configuration of a tire 10 according to the present embodiment is described with reference to FIG. 1. A tread pattern formed by a plurality of blocks 13 defined by a plurality of circumferential direction grooves 11 extended along a tire circumferential direction shown by an arrow A and a plurality of lateral grooves 12 crossing the circumferential direction groove 11 is formed on a tread surface of the tire 10. The lateral groove 12 is extended along a tire width direction shown by an arrow B.

A plurality of sipes 14 is formed on a wheel tread portion of the block 13. Specifically, the sipe 14 is formed linearly in a tire width direction. Here, the shape of the sipe 14 is not limited to a linear shape. The sipe 14 may be formed in a zigzag shape, a corrugated shape, or a crank shape.

Next, a configuration of a tire mold 20 is described with reference to FIG. 2. The tire mold 20 is a mold having a mold surface for vulcanizing and molding the tire 10. As shown in FIG. 2, the tire mold 20 includes a block surface molding portion 22 for molding a surface of each block 13 that forms the tread pattern, a bone portion 24 for molding the circumferential direction grooves 11 and the lateral grooves 12 of the tread pattern, and a plurality of blades 26 for molding a plurality of the sipes 14. The blades 26 are arranged on each block surface molding portion 22 with a gap therebetween. A concave-convex surface is formed on a side surface of the blade 26.

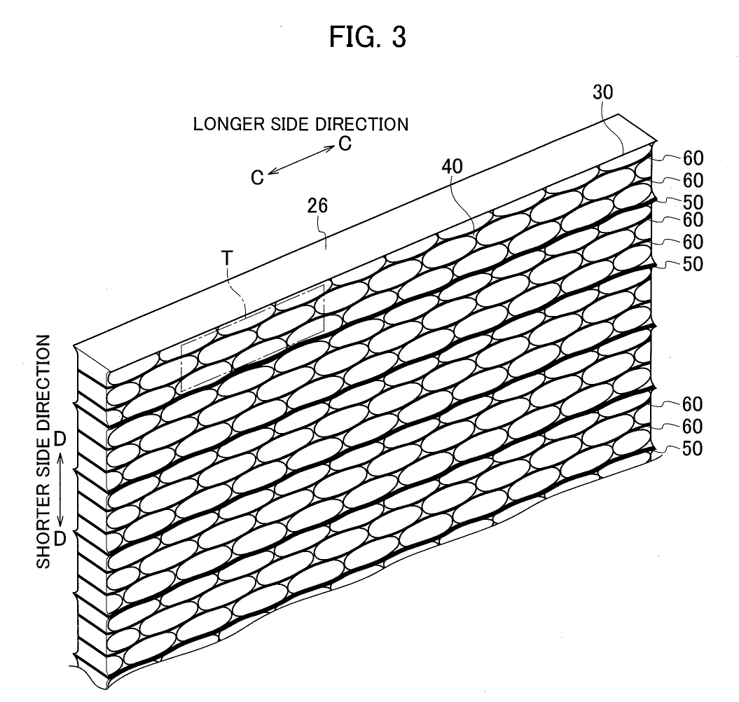

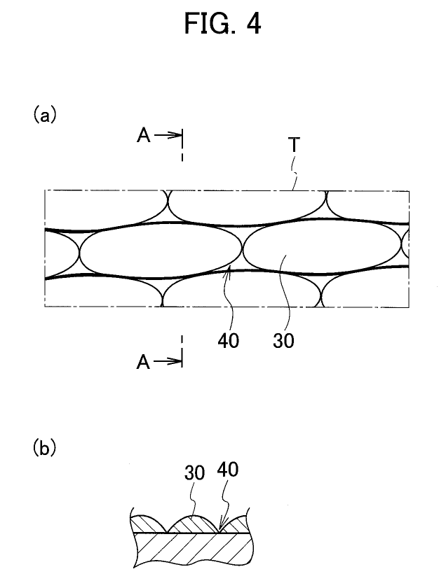

The tire 10 is manufactured by being vulcanized and molded by the tire mold 20. Further, when rubber is entered into the concave-convex surface of the blade 26, a concave-convex surface is formed on each of inner wall surfaces facing each other of the sipe 14 (hereinafter, merely referred to as an inner wall surface of the sipe 14). The concave-convex surface of the blade 26 is described with reference to FIG. 3, and FIGS. 4(a) and 4(b).

As shown in FIG. 3, the blade 26 is formed in a plate shape having a plate thickness corresponding to a width of the sipe 14. A convex portion 30 and a concave portion 40 are formed on the side surface of the blade 26. The convex portion 30 and the concave portion 40 are transferred so as to form the concave-convex surface of the inner wall surface of the sipe 14.

Further, as shown in FIG. 3, the convex portions 30, each of which has an oval shape, are continuously formed along a longitudinal direction (tire width direction) of the blade 26 shown by an arrow C, on the side surface of the blade 26. Further, the convex portions 30 are laminated along a depth direction (tire radial direction) of the blade 26 shown by an arrow D. In the present embodiment, the convex portion 30 is formed in an oval shape, however a shape of the convex portion 30 is not limited to an oval shape, and therefore the convex portion 30 may be formed in other shape. Further, the convex portions 30 arranged adjacent to each other may be overlapped with each other. The blade 26 is relatively easily manufactured by using, for example, a precision casting method using a collapsible mold formed of plaster or the like, an electroforming method (a manufacturing method of a metal product using electroplating), a diffusion bonding method (a bonding method using diffusion of atoms caused between bonded surfaces while pressurizing base materials to adhere to each other to such an extent in which plastic deformation is hardly caused at a temperature less than a melting point of the base material), or a lamination forming method.

Further, as shown in FIG. 3 and FIG. 4(a), the concave portions 40 are formed between the convex portions 30 adjacent to each other. In other words, the concave portions 40 are formed irregularly to make a coarse-dense distribution and to fill a gap between the convex portions 30 adjacent to each other.

A longer side length of the convex portion 30 is set in a range between 0.085 mm and 0.4 mm. A shorter side length of the convex portion 30 is set in a range between 0.035 mm and 0.165 mm. The longer side length of the convex portion 30 is preferably set in a range between 0.125 mm and 0.375 mm. The shorter side length of the convex portion 30 is preferably set in a range between 0.05 mm and 0.15 mm. The longer side length of the convex portion 30 is more preferably set in a range between 0.165 mm and 0.335 mm. The shorter side length of the convex portion 30 is more preferably set in a range between 0.065 mm and 0.135 mm. Further, the convex portions 30 are formed at an interval of 0.035 mm to 0.165 mm in the depth direction of the blade 26.

An average width length of the concave portions 40 is set in a range between 0.0005 mm and 0.5 mm when the side surface of the blade 26 is seen from the front thereof (concave-convex surface view). Here, the average width length of the concave portions 40 is not a length in a width direction defined by the longitudinal direction of the blade 26 but an average length of a length of a maximum length portion and a length of a minimum length portion of the concave portion 40 having an outline of a polygonal shape. Further, the average width length of the concave portions 40 is preferably set in a range between 0.005 mm and 0.35 mm. The average width length of the concave portions 40 is more preferably set in a range between 0.05 mm and 0.2 mm. Further, an area of the concave portion 40 is set in a range between 0.0000002 mm² and 0.2 mm². The area of the concave portion 40 is preferably set in a range between 0.00002 mm² and 0.1 mm². The area of the concave portion 40 is more preferably set in a range between 0.002 mm² and 0.03 mm². Further, a depth of the concave portion 40 is set in a range between 0.0001 mm and 0.25 mm. The depth of the concave portion 40 is preferably set in a range between 0.0025 mm and 0.18 mm. The depth of the concave portion 40 is more preferably set in a range between 0.005 mm and 0.12 mm. Further, a height of the convex portion 30 is set in a range between 0.0001 mm and 0.25 mm. The height of the convex portion 30 is preferably set in a range between 0.0025 mm and 0.18 mm. The height of the convex portion 30 is more preferably set in a range between 0.005 mm and 0.12 mm.

The shape of the outline of the concave portion 40 is not a circular shape and an oval shape but a polygonal shape having many sides and having many concave-convex surfaces on the outline.

Further, as shown in FIG. 4(b), the concave portion 40 is formed in a sharp shape having a sharp distal end toward the side surface of the blade 26. In other words, the concave portion 40 is sharp in a depth direction of the concave portion 40.

Further, a length of the concave portion 40 is smaller than a length of the convex portion 30 when the side surface of the blade 26 is seen from the front thereof.

Further, as shown in FIG. 3, a first layer 50 and a second layer 60 are formed on the side surface of the blade 26. Specifically, each of the first layer 50 and the second layer 60 is formed as a layer extended from one end to another end of the blade 26 along the longitudinal direction of the blade 26. The first layer 50 and the second layer 60 are formed when the blade 26 is manufactured by using the method described above. Further, a shape of each of the first layer 50 and the second layer 60 is formed in a corrugated shape.

As shown in FIG. 3, the first layers 50 are formed in a step-like shape so as to be adjacent to each other at an interval of 0.1 mm to 0.5 mm in the depth direction of the blade 26. The first layers 50 are preferably formed to be adjacent to each other at an interval of 0.15 mm to 0.45 mm in the depth direction of the blade 26. The first layers 50 are more preferably formed to be adjacent to each other at an interval of 0.2 mm to 0.4 mm.

As shown in FIG. 3, the second layers 60 are formed between the first layers 50 at an interval smaller than that of the first layers 50. The second layers 60 are formed in a step-like shape so as to be adjacent to each other at an interval of 0.035 mm to 0.165 mm in the depth direction of the blade 26. The second layers 60 are preferably formed to be adjacent to each other at an interval of 0.05 mm to 0.15 mm in the depth direction of the blade 26. The second layers 60 are more preferably formed to be adjacent to each other at an interval of 0.065 mm to 0.135 mm in the depth direction of the blade 26.

Next, a concave-convex surface (not shown) formed on the inner wall surface of the sipe 14 is described. Hereinafter, a convex portion formed on the inner wall surface of the sipe 14 is merely called a convex portion of the sipe 14, or a convex portion. Further, a concave portion formed on the inner wall surface of the sipe 14 is merely called a concave portion of the sipe 14, or a concave portion.

The concave portions, each of which has an oval shape, are continuously formed on the inner wall surface of the sipe 14, along the longitudinal direction (tire width direction) of the sipe 14. Further, the concave portions are laminated along a depth direction (tire radial direction) of the sipe 14. In the present embodiment, the concave portion of the sipe 14 is formed in an oval shape, however the shape of the concave portion is not limited to the oval shape, and therefore the concave portion may be formed in other shape. Further, the concave portions of the sipe 14 adjacent to each other may be overlapped with each other.

Further, the convex portions are formed between the concave portions adjacent to each other. In other words, the convex portions of the sipe 14 are formed irregularly to make a coarse-dense distribution and to fill a gap between the concave portions adjacent to each other.

A shape of an outline of the concave portion of the sipe 14 is not a circular shape and an oval shape but a polygonal shape having many sides and having many concave-convex surfaces on the outline. Further, the convex portion of the sipe 14 is formed in a sharp shape having a sharp distal end toward the inner side wall facing the sipe 14. In other words, the convex portion of the sipe 14 is sharp in a depth direction of the convex portion of the sipe 14.

An average width length of the convex portions of the sipe 14 is set in a range between 0.0005 mm and 0.5 mm when the inner wall surface of the sipe 14 is seen from the front thereof (concave-convex surface view). The average width length of the convex portions of the sipe 14 is preferably set in a range between 0.005 mm and 0.35 mm. The average width length of the convex portions of the sipe 14 is more preferably set in a range between 0.05 mm and 0.2 mm. Here, an area of the convex portion of the sipe 14 is set in a range between 0.0000002 mm² and 0.2 mm². The area of the convex portion of the sipe 14 is preferably set in a range between 0.00002 mm² and 0.1 mm². The area of the convex portion of the sipe 14 is more preferably set in a range between 0.002 mm² and 0.03 mm². Further, a height of the convex portion of the sipe 14 is set in a range between 0.0001 mm and 0.25 mm. The height of the convex portion of the sipe 14 is preferably set in a range between 0.0025 mm and 0.18 mm. The height of the convex portion of the sipe 14 is more preferably set in a range between 0.005 mm and 0.12 mm.

A longer side length of the concave portion of the sipe 14 is set in a range between 0.085 mm and 0.4 mm. A shorter side length of the concave portion of the sipe 14 is set in a range between 0.035 mm and 0.165 mm. The longer side length of the concave portion of the sipe 14 is preferably set in a range between 0.125 mm and 0.375 mm. The shorter side length of the concave portion of the sipe 14 is preferably set in a range between 0.05 mm and 0.15 mm. The longer side length of the concave portion of the sipe 14 is more preferably set in a range between 0.165 mm and 0.335 mm. The shorter side length of the concave portion of the sipe 14 is more preferably set in a range between 0.065 mm and 0.135 mm. Further, the concave portions of the sipe 14 are formed at an interval of 0.035 mm to 0.165 mm in the depth direction of the sipe 14.

Further, a length of the convex portion of the sipe 14 is smaller than a length of the concave portion of the sipe 14 when the inner wall surface of the sipe 14 is seen from the front thereof.

Further, layers to which the first layer 50 and the second layer 60 shown in FIG. 3 are transferred are formed on the inner wall surface of the sipe 14. Hereinafter, a layer to which the first layer 50 is transferred is called a first layer formed in the sipe 14. Further, a layer to which the second layer 60 is transferred is called a second layer formed in the sipe 14. Each of the first layer and the second layer formed in the sipe 14 is extended from one end to another end of the sipe 14 in the longitudinal direction of the sipe 14. Further, each shape of the first layer and the second layer formed in the sipe 14 is formed in a corrugated shape.

The first layers formed in the sipe 14 are formed in a step-like shape so as to be adjacent to each other at an interval of 0.1 mm to 0.5 mm in the depth direction of the sipe 14. The first layers formed in the sipe 14 are preferably formed to be adjacent to each other at an interval of 0.15 mm to 0.45 mm. The first layers formed in the sipe 14 are more preferably formed to be adjacent to each other at an interval of 0.2 mm to 0.4 mm.

Further, the second layers formed in the sipe 14 are formed between the first layers formed in the sipe 14 at an interval smaller than that of the first layers formed in the sipe 14. The second layers formed in the sipe 14 are formed in a step-like shape so as to be adjacent to each other at an interval of 0.035 mm to 0.165 mm. The second layers formed in the sipe 14 are preferably formed to be adjacent to each other at an interval of 0.05 mm to 0.15 mm. The second layers formed in the sipe 14 are more preferably formed to be adjacent to each other at an interval of 0.065 mm to 0.135 mm.

### Functions and Effects

As described above, according to the present embodiment, the following functions and effects can be obtained.

The convex portion 30 and the concave portion 40 formed in the blade 26 are transferred, so that the sharp convex portion is formed on the inner wall surface of the sipe 14. Accordingly, when the bending deformation of the block 13 is caused in braking or driving of the tire 10, a relatively large friction resistance is generated due to a contact between the convex portions on the inner wall surface of the sipe 14. Consequently, rigidity of the block 13 (hereinafter, merely referred to as block rigidity) in which the sipe 14 is formed is improved. Thus, the deformation of the block 13 is suppressed.

Further, the first layers 50 formed in the blade 26 are transferred, so that the first layers are formed in a step-like shape on the inner wall surface of the sipe 14. When the bending deformation of the block 13 is caused in braking or driving of the tire 10, the first layers formed in a step-like shape mutually support the inner wall surface of the sipe 14. Consequently, the block rigidity is improved.

Further, the second layers 60 formed in the blade 26 are transferred, so that the second layers are formed in a step-like shape on the inner wall surface of the sipe 14. The second layer formed in the sipe 14 is formed between the first layers formed in the sipe 14. When the bending deformation of the block 13 is caused in braking or driving of the tire 10, the first layer and the second layer formed in a step-like shape mutually support the inner wall surface of the sipe 14. Consequently, the block rigidity is further improved.

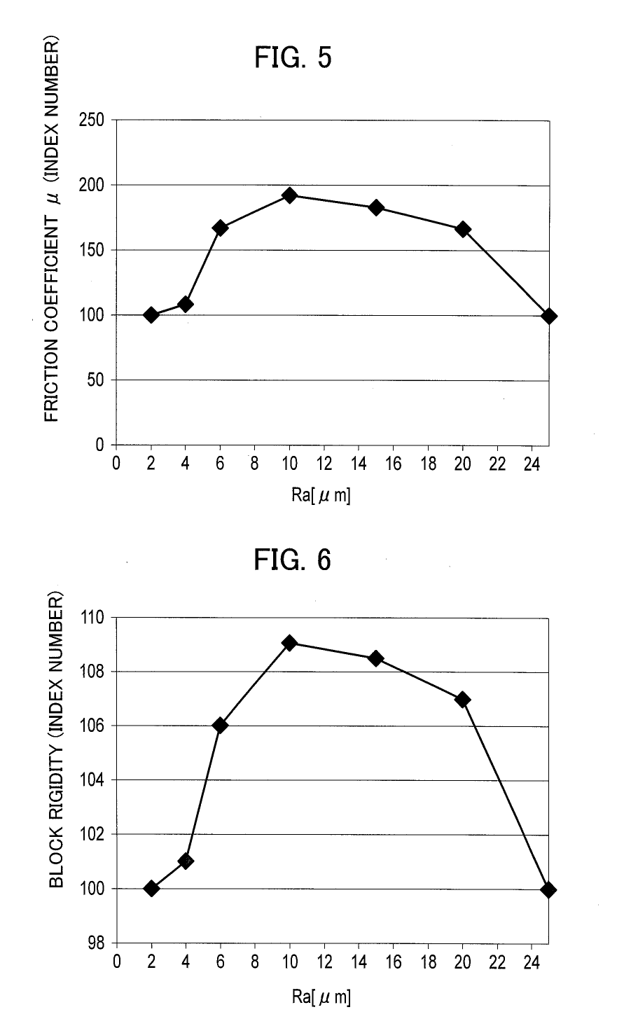

Further, arithmetic average roughness Ra of the concave-convex surface formed in the blade 26 (hereinafter, it is similarly applied to the transferred concave-convex surface in the sipe 14) is preferably set in a range between 6 μm and 20 μm. As shown in FIG. 5, in a case in which the arithmetic average roughness Ra is set in a range between 6 μm and 20 μm, a friction coefficient μ between rubber and rubber is largely improved. This is because rubber surfaces are meshed with each other when the arithmetic average roughness Ra is set in the range between 6 μm and 20 μm. On the other hand, in a case in which the arithmetic average roughness Ra is less than 6 μm, the rubber surfaces are excessively smooth and slippery. Consequently, the rubber surfaces are not meshed with each other. Further, in a case in which the arithmetic average roughness Ra is more than 20 μm, the rubber surfaces are excessively rough and a large gap is generated. Consequently, the rubber surfaces are not meshed with each other. Here, an evaluation length, a reference length, and the like relating to the arithmetic average roughness Ra in the present embodiment are based on JIS standard.

Further, in a case in which the arithmetic average roughness Ra is in the range between 6 μm and 20 μm, the friction coefficient μ between rubber and rubber is largely improved, and therefore the block rigidity is largely improved as shown in FIG. 6.

With the lengths of the convex portion 30 and the concave portion 40 described above, the arithmetic average roughness Ra of the concave-convex surface is set in the range between 6 μm and 20 μm.

### Evaluation Result

Hereinafter, an evaluation result is described. Specifically, samples described below were prepared, and the friction coefficient μ (index number) between rubbers, the block rigidity (index number), and DRY braking performance (index number) of each sample were measured.

As the samples, a sample according to a conventional example, samples according to comparative examples 1 and 2, and samples according to examples 1 to 6 were prepared. A tire size of each sample is 195/65R15, and a parameter of each sample is shown in Table 1.

### Friction Coefficient μ

In a friction test, the friction coefficient μ between rubbers was measured. A measured result is shown in Table 1. The measured result is indexed as the result of the sample according to the conventional example 1 is defined as 100. As the value is larger, the friction coefficient μ is superior.

### Block Rigidity

In a block rigidity test, the block rigidity was measured. A measured result is shown in Table 1. The measured result is indexed as the result of the sample according to the conventional example 1 is defined as 100. As the value is larger, the block rigidity is superior.

### DRY Braking Performance

In a DRY braking test, a stop distance was measured by braking at a speed of 100 km/h on a dry road surface. A measured result is shown in Table 1. The measured result is indexed as the result of the sample according to the conventional example 1 is defined as 100. As the value is larger, the DRY braking performance is superior.

TABLE 1

| | Conventional | Comparative | | | | | | | Comparative |
|---|---|---|---|---|---|---|---|---|---|
| | example | example 1 | Example 1 | Example 2 | Example 3 | Example 4 | Example 5 | Example 6 | example 2 |
| | Ra = 2 | Ra = 5 | Ra = 6 | Ra = 8 | Ra = 10 | Ra = 15 | Ra = 18 | Ra = 24 | Ra = 25 |
| Friction | 100 | 135 | 170 | 178 | 190 | 180 | 172 | 110 | 100 |
| coefficient μ | | | | | | | | | |
| Block rigidity | 100 | 103.5 | 106 | 107.5 | 109 | 108.5 | 107.5 | 100.5 | 100 |
| DRY braking | 100 | 101 | 103 | 104 | 105 | 105 | 104 | 104 | 100 |
| performance | | | | | | | | | |

In the tire according to the conventional example shown in Table 1, the convex portion and the concave portion formed in the sipe of the present embodiment are not formed. Further, in the tires according to the examples 1 and 6 shown in Table 1, each of the convex portion 30 and the concave portion 40 of the blade 26 is set in the following length. That is, the longer side length of the convex portion 30 is set in a range between 0.085 mm and 0.4 mm, the shorter side length of the convex portion 30 is set in a range between 0.035 mm and 0.165 mm, the average width length of the concave portions 40 is set in a range between 0.0005 mm and 0.5 mm, the area of the concave portion 40 is set in a range between 0.0000002 mm² and 0.2 mm², and the depth of the concave portion 40 is set in a range between 0.0001 mm and 0.25 mm.

Further, in the tires according to the examples 2 and 5 shown in Table 1, each of the convex portion 30 and the concave portion 40 of the blade 26 is set in the following length. That is, the longer side length of the convex portion 30 is set in a range between 0.125 mm and 0.375 mm, the shorter side length of the convex portion 30 is set in a range between 0.05 mm and 0.15 mm, the average width length of the concave portions 40 is set in a range between 0.005 mm and 0.35 mm, the area of the concave portion 40 is set in a range between 0.00002 mm² and 0.1 mm², and the depth of the concave portion 40 is set in a range between 0.0025 mm and 0.18 mm.

Further, in the tire according to the examples 3 and 4 shown in Table 1, each of the convex portion 30 and the concave portion 40 of the blade 26 is set in the following length. That is, the longer side length of the convex portion 30 is set in a range between 0.165 mm and 0.335 mm, the shorter side length of the convex portion 30 is set in a range between 0.065 mm and 0.135 mm, the average width length of the concave portions 40 is set in a range between 0.05 mm and 0.2 mm, the area of the concave portion 40 is set in a range between 0.002 mm² and 0.03 mm², and the depth of the concave portion 40 is set in a range between 0.005 mm and 0.12 mm.

Further, in the tires according to the comparative examples 1 and 2 shown in Table 1, each the convex portion 30 and the concave portion 40 is set out of the range of each of the convex portion 30 and the concave portion 40 of the tires according to the examples 1 and 6 shown in Table 1.

According to the result shown in Table 1, in the tires according to the examples 1 to 6, the friction coefficient, the block rigidity, and the DRY braking performance are superior compared to those of the tires according to the conventional example and the comparative examples 1 and 2.

As described above, the embodiment of the present invention is described, however the present invention is not limited to the description and the drawings forming a part of the present disclosure. Various modifications, examples, and operation techniques will be apparent from the present disclosure to a person skilled in the art.

For example, in the present embodiment, the convex portions 30 are formed continuously along the longitudinal direction of the blade 26, however it is not limited to this. The convex portions 30 may be formed continuously along the depth direction of the blade 26. In a case in which the convex portions 30 are formed continuously along the depth direction of the blade 26, the convex portions 30 are laminated along the longitudinal direction of the blade 26. Further, in a case in which the convex portions 30 are formed continuously along the depth direction of the blade 26, each of the first layer 50 and the second layer 60 is extended along the depth direction of the blade 26 from one end to another end of the blade 26. Further, in a case in which the convex portions 30 are formed continuously along the depth direction of the blade 26, each of the first layers 50 and the second layers 60 are formed in a step-like shape so as to be adjacent to each other at a predetermined interval in the longitudinal direction of the blade 26. In other words, each of the first layers 50 and the second layers 60 are formed in a step-like shape so as to be adjacent to each other at a predetermined interval in a direction orthogonal to its extending direction (predetermined direction).

Further, the convex portions 30 may be formed continuously along a certain direction of the blade 26. In a case in which the convex portions 30 are formed continuously along a certain direction of the blade 26, the convex portions 30 are laminated in a direction orthogonal to the certain direction.

The entire contents of Japanese Patent Application No. 2016-076377 (filed on Apr. 6, 2016) are incorporated herein by reference.

### REFERENCE SIGNS LIST

10: tire
11: circumferential direction groove
12: lateral groove
13: block
14: sipe
20: tire mold
22: block surface molding portion
24: bone portion
26: blade
30: convex portion
40: concave portion
50: first layer
60: second layer

1. A tire mold comprising:
a mold surface that vulcanizes and molds a tire; and
a blade that vulcanizes and molds a sipe in the tire, the blade being formed on the mold surface,
wherein:
the blade includes a concave-convex surface in which a plurality of convex portions formed adjacent to each other and a plurality of concave portions formed between the convex portions adjacent to each other are formed;
a length of the concave portion is smaller than a length of the convex portion in a concave-convex surface view; and
the concave portion is sharp in a depth direction of the concave portion.

2. The tire mold according to claim 1, wherein:
an average width length of the concave portions is set in a range between 0.0005 mm and 0.5 mm in the concave-convex surface view;
an area of the concave portion is set in a range between 0.0000002 mm2 and 0.2 mm2; and
a depth of the concave portion is set in a range between 0.0001 mm and 0.25 mm.

3. The tire mold according to claim 1, wherein:
a first layer extended from one end to another end in a predetermined direction of the blade is formed on a side surface of the blade; and
the first layers are formed adjacent to each other in a direction orthogonal to the predetermined direction at an interval of 0.1 mm to 0.5 mm.

4. The tire mold according to claim 3, wherein:
a second layer extended from one end to another end in the predetermined direction of the blade is formed on the side surface of the blade; and
the second layers are formed between the first layers to be adjacent to each other in a direction orthogonal to the predetermined direction at an interval of 0.035 mm to 0.165 mm.

5. The tire mold according to claim 1, wherein:
a longer side length of the convex portion is set in a range between 0.085 mm and 0.4 mm;
a shorter side length of the convex portion is set in a range between 0.035 mm and 0.165 mm; and
the convex portions are formed in a predetermined direction of the blade at an interval of 0.035 mm to 0.165 mm.

6. A tire comprising:
a tread surface;
a plurality of circumferential direction grooves formed on the tread surface and extended in a tire circumferential direction;
a plurality of lateral grooves formed on the tread surface and extended in a tire width direction, the lateral groove crossing the circumferential direction groove;
a block formed in the tread surface and defined by a plurality of the circumferential direction grooves and a plurality of the lateral grooves; and
a plurality of sipes extended in the tire width direction and formed in the block,
wherein:
each of inner wall surfaces facing each other of the sipe includes a concave-convex surface in which a plurality of concave portions formed adjacent to each other and a plurality of convex portions formed between the concave portions adjacent to each other are formed;
a length of the convex portion is smaller than a length of the concave portion in a concave-convex surface view; and
the convex portion is sharp in a depth direction of the convex portion.

7. The tire according to claim 6, wherein:
an average width length of the convex portions is set in a range between 0.0005 mm and 0.5 mm in the concave-convex surface view;
an area of the convex portion is set in a range between 0.0000002 mm2 and 0.2 mm2; and
a depth of the convex portion is set in a range between 0.0001 mm and 0.25 mm.

8. The tire according to claim 6, wherein:
a first layer extended from one side to another side in a predetermined direction of the sipe is formed on each of the inner wall surfaces facing each other of the sipe; and
the first layers are formed in a direction orthogonal to the predetermined direction to be adjacent to each other at an interval of 0.1 mm to 0.5 mm.

9. The tire according to claim 6, wherein:
a longer side length of the concave portion is set in a range between 0.085 mm and 0.4 mm;
a shorter side length of the concave portion is set in a range between 0.035 mm and 0.165 mm; and
the concave portions are formed in a predetermined direction of the sipe at an interval of 0.035 mm and 0.165 mm.
